(19) United States
(12) Patent Application Publication
(10) Pub. No.: US 2011/0179882 A1
(43) Pub. Date: Jul. 28, 2011

(54) Bearing Durability Test Apparatus and Method

(76) Inventor: Cory Koglin, Richmond, VA (US)

(21) Appl. No.: 12/694,633

(22) Filed: Jan. 27, 2010

(51) Int. Cl. G01L 3/00

(52) U.S. Cl. 73/862.08

(57) ABSTRACT

A bearing durability test for automotive axle lubricant has been devised to assess lubricant requirements for bearing durability. Although various tests exist for differential lubricants to test for gear wear and other factors, the applicant has assessed a need and met that need with a bearing durability test and test rig apparatus.

### FIELD OF THE INVENTION

The present invention relates to a test apparatus and method of operation for evaluating the durability of bearings principally in limited slip differentials, and in particular, bearings in differentials which may pass current gear wear testing protocols.

### DESCRIPTION OF RELATED ART

Currently, there are a number of automotive tests aimed at the performance of specific automotive components. There is an L-37 standard test and an L-37 low temperature variation. These tests are also known as ASTMD-6121 and are generally utilized to evaluate load-carrying wear and extreme pressure properties of a gear lubricant in a hypoid axle under conditions of low-speed, high torque operation.

A typical L-37 test consists of a hypoid axle connected to a V-8 gasoline power engine with an automatic transmission through a drive shaft. Load on the axles is controlled by two large dynamometers connected to each end of axle. A high speed, low torque break in occurs at 440 axle rpm, 295° F. lubricant temperature and 394 lb-ft (9460 lb-in) of torque for 100 minutes, Following the initial wear-in phase, a low speed test is conducted for twenty-four hours at roughly 80 axle rpm at 1740 lb-ft (41,800 lb-in) (2359 N-MM) torque per wheel with axle temperature maintained near a constant 135° C. (275° F.). At the end of the test, the ring and pinion gears are inspected for basic wear, adhesive wear, plastic defamation and surface fatigue. Under operating test conditions, the L-37 test is normally considered to be a severe test that can discriminate between gear lubes capable of protecting gears and those that cannot. However, the L-37 test primarily looks at gear wear and pitting performance. It is not believed by the applicant to adequately predict bearing durability. In fact, the applicant has had gear lubricants successfully pass the L-37 test, only to fail on-road tests such as the on-road R-392 test developed by Ford Motor Company. As one can imagine, taking a lubricant onto on road to an in vehicle situation and failing is not advantageous.

The R-392 test is an on-road, in vehicle test that covers roughly 10,000 miles. Pinion head bearings are the predominant point of failure by fatigue damage on an inner race raceway. Accordingly, R-392 is a good test to evaluate axle test focused on bearings. However, the R-392 takes an actual vehicle with a trailer with a combined weight of 14,000 pounds over a route encompassing city and highway driving which takes fourteen days to complete in Arizona. This can be particularly expensive for east coast manufacturers to travel to Arizona, purchase a new truck and conduct a 14-day test.

There are other tests normally performed on differentials including the L-42 test which looks principally at lubricant effect on gear scuffing. There is also an L-60-1 test which evaluates thermal and oxidative stability of lubricating oils. An FE-8 test is a bearing test directed at wind turbine performance. Other test procedures are also available to test lubricants under various conditions but neither are believed to adequately address bearing durability, particularly in differentials.

Accordingly, a bearing durability test is believed to be necessary to provide capability while providing repeatable results in an effort to determine pass-fail qualities for gear lubricants as it relates to bearing durability preferably without undergoing an in-vehicle test.

Another need exists for a laboratory test which can accurately predict satisfactory gear lubricant performance as it relates to bearing durability.

### SUMMARY OF THE INVENTION

It is object of the present invention to provide an improved bearing durability test apparatus and/or method of its use.

It is another object of a presently preferred embodiment of the present invention to provide an improved testing system for evaluating bearing durability, and more particularly to a method of evaluating bearing durability with a lubricant utilized therewith.

The preferred test utilized has components somewhat similar to that specified by ASTMD-6121 (L-37 axle test) in that axle dynamometers are connected to an axle such as a Ford 8.8″ hypoid axle with a 3.73 gear ratio. A V-8 engine such as a 5.7 liter 350cid spark ignition engine and a 4-speed automatic transmission such as a GM 4L60E may be employed. A pinion torque meter such as a Himmelstein MCRT non-contact torquemeter from 0 to 2035 Nm (0-18,000 lb-in) range was connected as well as a J-type thermocouple. Finally, in-house software for use in test control and a data acquisition rate of a data sample every 20 seconds were employed. Other sample data periods and other software could also be utilized.

The specific test conditions were derived based on conditions experienced in the R-392 test. The R-392 test is an on-road test in which engineers evaluated the conditions under which the truck and its differential would be operating under such a test. Specifically, in that test a light duty truck pulls a loaded trailer over very specific routes in high ambient temperatures. The various vehicle manufacturer have specific test routes and requirements including the total miles driven, grade loads and the order of driving the routes.

Various segments of the R-392 test were evaluated and simulated with the applicant's new test. Specifically, there is a Toprock Hill segment which consists of a 1000-foot elevation climb over 17 miles at 70 mph. There is also Union Pass segment which consists of a 3,000 foot elevation climb over 17 miles at 60 mph maximum. There is a High Speed Track segment consisting of driving 70 mph on a level track. Furthermore, there is a City Traffic segment which includes rolling stops. In order to simulate these various segments and others, the applicant has created a series of different pinion torques provided different times and at various speeds to simulate these various high stress environments in a bench test as opposed to a vehicle test. The results have been quite amazing. These segments were incorporated into the software for providing a repeatable. By providing such a test, differentials and lubricants which passed the L-37 still have been found to possibly fail the bearing durability test employed by the applicant's method when these components fail the F-392 test. The applicant's test provides a significant savings as it relates to testing of lubricants in vehicles in on-road conditions.

### BRIEF DESCRIPTION OF THE DRAWINGS

The particular features and advantages of the invention as well as other objects will become apparent from the following description taken in connection with the accompanying drawings in which:

FIG. 1a shows a schematic drawing of a test rig configuration of a presently preferred embodiment of the present invention with a schematic detail of internal portions of a differential;

FIG. 2 shows a vibration trace of a line showing failure on a last day in the test preferred on a rig as shown in FIG. 1;

FIG. 3 shows a failed bearing from the differential shown in FIG. 1;

FIG. 4 shows a graph of iron count versus number of test cycles showing differences between failing and passing lubricants after the presently preferred test run on the rig of FIG. 1 has been performed; and

FIG. 5 shows a chart of calculated L10 lives based on actual revolutions and pinion revolutions for the differential shown in FIG. 1.

### DETAILED DESCRIPTION OF THE DRAWINGS

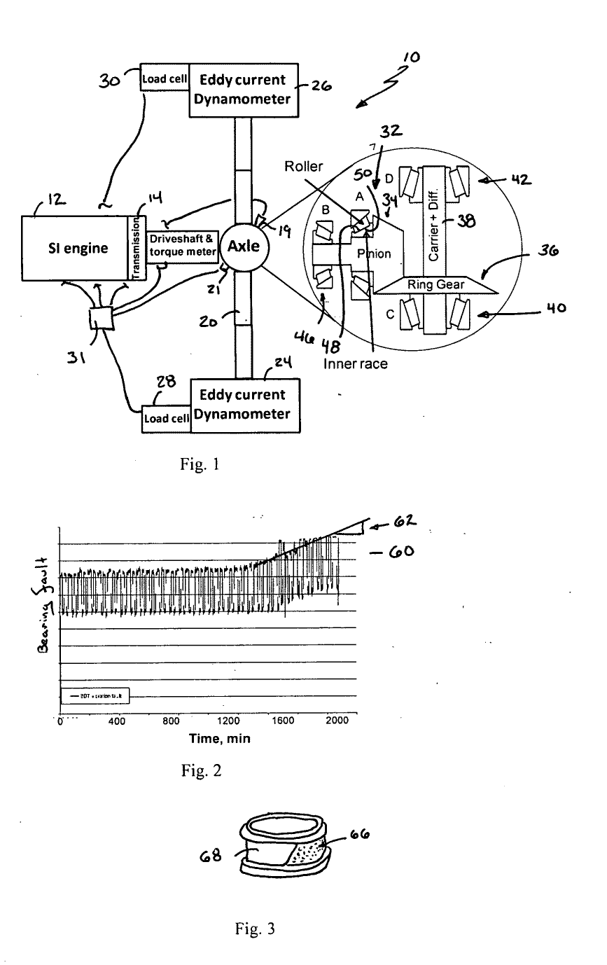

FIG. 1 shows the schematic of a bearing durability test rig 10. The test rig is comprised of an engine 12, transmission 14, and drive shaft and torque meter 16 coupled to a differential 18, supporting axles portions 20 and 22 respectively connected to dynamometers 24,26 for which each have respective load cells 28,30. Computer 31 controls at least some of the components during test operation and receives input from components such as torque meter 16 and temperature sensor 21. Cooling system 23 such as a water cooler can be utilized to maintain or at least prevent differential from exceeding a set temperature.

Schematic of differential 18 is shown in detail in FIG. 1b with bearing 32 supporting pinion gear 34 which contacts ring gear 36 as well as carrier and differentials 38 supported by respective bearings 40,42. Differential 18 transfers power along axle portions 20,22 as is provided from drive shaft 16. Pinion gear at shaft 44 which may be supported by bearing 46, Although this is a simple schematic of a differential 18, those of ordinary skill in the art realize that there are a few number of design variations in differentials across the various vehicles depending on model and manufacturer. The basic idea of transferring rotation along one axis into a perpendicular axis is a general objective of most differentials 18. The wear of a pinion gear 34 against ring gear 36 is what a traditionally being evaluated by such tests as the L-37 (ASTMD 6121) test. Until now, tests to evaluate wear on bearings such as bearing 32 specifically have been restricted to vehicle field tests relying on performance in actual vehicles instead of in laboratory environments such as with test rig 10.

As fuel economy becomes a more and more important objective for auto manufacturers, providing improved and new lubricants is an objective to preferably minimize friction or inertia while maintaining satisfactory lubrication and preventing excessive wear of parts whether it be gears, bearings, or other portions of differentials or other components in the drive game. Other factors may drive new lubricant development in the future. Tests such as the L-37 test have adequately predicted gear wear and gear pitting performance, but it is possible to pass the L-37 test and still fail bearing durability tests in on-road conditions such as the F-392 test. In order to more accurately predict whether or not an axle lubricant in a driven automobile will pass in a driven vehicle, a more effective bench test using a test platform such as rig 10 is believed to be desirable.

A test is preferably provided in an effort to simulate at least portions of an actual road bearing durability test in a lab environment. A specific road segment cycle has been selected which is believed to impart road test loading conditions while reducing test time and speed up lubricant development and evaluation procedures as opposed to performing a 10,000 mile road test in the state of Arizona in an actual vehicle.

An object of this test is to utilize a test rig 10 to at least assist in developing and/or testing lubricants in an effort to resist bearing raceway fatigue spalling particularly at the head of the pinion head bearing 32. Pinion head bearing 32 is shown in FIG. 1b with inner race 48 located where it contacts roller 50. This location is a position of particular concern in many applications. Other bearings may be evaluated as well.

The pinion head bearing 32 may very well experience the toughest bearing application position in the differential 18. The loading on the pinion bearing 32 is believed to be complex due to the thrust force of rotating gear torques that the bearing 32 typically supports. Bearing inner race rib-roller end scuffing is also may be expected to be evaluated but is often of secondary interest. In evaluating these bearing 32 after conducting a test, there are a number of spall initiation modes which have been reported such as by T. E. Tallian and ASNV in a 1992 article entitled “Failure Atlas for Hertz Contact Machine Elements” as well as Littmann and Widner in their publication Bearing Damage Analysis, Mechanical Failure-Definition of the Problem. NBS Special Publication No. 423 (Available from Supt. Of Documents, U.S. Govt. Printing Office, Washington, D.C.). 1976, 67-84.

One of the primary spall initiation modes in differentials are believed to be PSO spalls initiated by surface stress raisers such as debris dents or micro-spalling due to thin EHL films resulting from high bearing temperatures. Inclusion origin spalls may also occur on occasion, but it is believed that modern steels may minimize the opportunity for this initiation mode. The temperatures inside the bearing at the raceway and rib-roller contacts can be somewhat hotter if not considerably hotter having thinner EHL films than would be suspected from the usual temperature measurements taken in the gear box sump. It may also be difficult to adequately lubricate the rib-roller contact location under these conditions and higher temperatures can also cause reduced fatigue life if the additives are not properly formulated. Therefore, in performing the test described below, it is likely important to examine the bearings after the test to see if rib wear has occurred besides head bearing spalling failure.

In developing an improved test which at least consistently predicts results of field, tests, the mechanisms that initiate fatigue damage should be the same, and the continued propagation of the spall and spread of the damage to other bearing components should also be similar in rate of development and appearance if the load, speed, and lubricant viscosity are replicating the field conditions. This is believed to be a basis for a need for this test in that the L-37 test can evaluate gear wear, but not necessarily predict bearing fatigue as examined by the presently preferred test.

Consequently, a bench test protocol that accurately produces performance of the lubricant and bearing formerly requiring a lengthy field test, is believed to be desirable, particularly when the initiated mechanisms and fatigue damage propagation mechanisms in the preferred embodiment mimic theoretical predictions. The objective of this test is to show that a bearing durability test rig 10 can be operated to simulate a vehicle test to evaluate bearings in the differential for durability. Furthermore, actual comparisons of the field test to the applicant's test have been compared to show repeatability of the test.

As explained above, the test of the presently preferred embodiment is believed to emulate a field test and in a presently preferred embodiment the Ford R-392 axle durability test. In the R-392 test pinion head bearings are predominately the components that fail the test by fatigue damage on the inner raceway. Accordingly, the applicant in performing an on-road R-392 test examined the various components of that test and set out to make a bench test to simulate the results to indicate failure for these components failing the field test while also passing those axles and differentials which pass the field test.

The R-392 test takes a vehicle with a trailer and a combined weight of 14,000 pounds over a route encompassing city and highway driving towing up a grade and coasting conditions. This test takes roughly 14 days to complete and after the test, the differential is torn down and visually inspected for damage. A passing criteria for the test is there is no fatigue damage on the bearing raceways and no bearing rib scuffing. Table I provided below shows the cycle segments from the R-392 test. Specifically, as a high speed track segment with a torque range of roughly 200-300 lb-ft, a pinion speed of 2,500-3,000 rpm, a temperature range as well as a % of time of the test on this track segment. There is also a Toprock Hill with a slightly graded torque and lower speed, a City traffic section with still slightly higher torque and slower pinion speed. Finally, there is a Union Pass segment which is a moderate torque range and a moderate pinion speed segment.

TABLE I
R-392 essential cycle segments and respective life depletion

| Cycle | | | | |
|---|---|---|---|---|
| segment | Torque range | Pinion speed | Temperature^{a} | |
| description | lb-ft | (rpm) | ° F. | % Time |
| High speed | 200-300 | 2,500-3,000 | 240-268^{b} | 21 |
| track | | | | |
| Topock Hill | 300-400 | 2,000-2,500 | 258-276 | 14 |
| City traffic | 400-600 | 500-1,000 | 251-252 | 27 |
| Union Pass | 300-401 | 2,000-2,500 | 264-270 | 21 |
| Interspersed | low | various | Not measured | 17 |
| remainder | | | | |

^{a}Range of maximum temperatures.
^{b}Data taken from Topock Hill access and Union Pass access runs of the simulated R-392 test carried out by Afton.

It is understood these are average ranges as many of these as in actual road conditions as particularly as taken between city and highway driving, towing up a grade and coasting conditions on public and private property there are many actual torques and pinion speeds encountered on these various segments. The applicant has merely sought to take an average range for the purpose of creating a bench test. From the Table I, Table II was created to provide repeatable cycle segments. An interesting column in this table is the % Revolution in representing the degree that the differential turns based on the various driving conditions empirically derived as would be expected to encountered by the differential.

TABLE II
BDT load cycle segments and respective life depletion

| Cycle | Pinion | | | Pinion | Wheel | | |
|---|---|---|---|---|---|---|---|
| segement | torque, | | | speed, | speed, | Temperature, | % Life |
| description | lb-ft | % Time | % Revolution | rpm | rpm | ° F. | depletion |
| Union Pass | 350 | 24 | 30 | 2,200 | 590 | 250 | 35 |
| City | 500 | 17 | 5 | 525 | 141 | 250 | 19 |
| driving-1 | | | | | | | |
| High speed | 225 | 25 | 37 | 2,600 | 697 | 250 | 10 |
| City | 500 | 17 | 5 | 525 | 141 | 250 | 19 |
| driving-2 | | | | | | | |
| Topock Hill | 300 | 17 | 23 | 2,400 | 643 | 250 | 16 |

As one can see, the torques are provided within the various torque ranges as are the pinion speeds. The engine and transmission can provide the desired pinion and wheel speed in coordination with maintenance of a desired torque and percent revolution for the various segments as provided in Table II. As one can see from evaluating Table II, the test rig 10 performance can be selected to preferably replicate the same damage results in the laboratory as provided in an automobile test.

The Union Pass segment is characterized by a relatively low torque (i.e., less than 750 lb-ft) and more particularly less than about 400 if not about 350 lb-ft of torque together with a high axle or wheel speed rpm than that of over about 500, and more particularly, over about 550 rpm. The City driving segment is that of a relatively low torque pinion torque value of less than 750 lb-ft) and more particularly less than about 500 lb-ft but having an axle speed of less than 200 rpm and more particularly, less than 150 rpm. A high speed segment has a low torque of less than about 500, and more particularly, less than about 250 lb-ft while the wheel speed is greater than 500 rpm, and, in fact, is greater than almost 700 rpm. A second city driving segment has similar characteristics as the first city driving segment and a Topock Hill segment has a relatively low torque at less than 500 lb-ft and more particularly about 300 lb-ft while it has a wheel speed of greater than about 500 rpm and more particularly roughly about 650 rpm. These segments are run for predetermined periods of time such as 35% of the time for the Union Pass segment, 19% of the time for the City driving-1 segment, 10% for the High speed segment, 19% for the City driving-2 segment, followed by 16% for the Topock Hill segment, and once all five segments are performed for their respective time segments, a first cycle is completed and then the second cycles begins with the start of another first segment. It is understood by those of ordinary skill in the art that the various segments may have different characteristics in different embodiments. It is worth noting that none of the known tests have a failure point directed to an a vibration sensor measuring a failure point related to exceeding a predetermined setting as it relates to the vibration associated with the differential 18. In particular, a trace such as FIG. 2 can be evaluated by the controller 31 and upon reaching a predetermined particular slope such as bearing fault over time and/or a predetermined bearing fault value or other determined value by the controller 31, the test can be deemed to reach a failure event. Another possibility is to run the test for a predetermined period of time such as 4/48 hours.

Low pinion torque may be defined in the presently preferred embodiment as less than about 750 lb-ft and more particularly less than about 500 lb-ft and high axle speed may be characterized as about 500 rpm whereas lower axle speed may be defined as less than about 200 rpm.

The high load city driving segment is broken into two sections to preferably help in avoiding overheating and to assist in keeping temperatures in line with that of the R-392 temperatures. The bench test is different from the field test in that the test segment is preferably not stopped after a certain length of time or miles such as the 10,000 miles driven in 14 days, but can continue until bearing damage is detected with a vibration sensor 19 such as an accelerometer vibration detector in connection with the differential 18. Testing to failure may provide a better determination of viability of a lubricant for the high stress application. Four test replicates may be conducted on each lubricant and the median life can be calculated with Weibull reliability methodology.

Using the drive shaft torque meter, a first order Milner's Rule based analysis can be performed of the test showing most of the fatigue damage appears to occur in the Union Pass and City Driving segments. The bearing lives, including the life adjustment factor a_{ISO}, can be estimated from bearing load, lubricant viscosity, and an assumed constant debris factor of 0.2. Hertzian contact stresses and EHL film thicknesses for each bearing position can be calculated and are shown in Table V below.

TABLE V
Cone contact stress, EHL film thickness, and a_{ISO}

| | | Contact | | |
|---|---|---|---|---|
| Pinion | | stress, | hc, micro- | |
| torque | Bearing | GPa | meters | a_{ISO} |
| 500 | A | 2.38 | 0.048 | 0.164 |
| | B | 1.6 | 0.045 | 0.205 |
| | C | 2.16 | 0.019 | 0.104 |
| | D | 1.47 | 0.021 | 0.105 |
| 350 | A | 1.98 | 0.138 | 0.308 |
| | B | 1.37 | 0.126 | 0.521 |
| | C | 1.8 | 0.067 | 0.207 |
| | D | 1.22 | 0.074 | 0.105 |

The test rig 10 utilized in the presently preferred embodiment utilizes a Ford 8.8 inch hypoid axle with a 3.73 gear ratio with the following test equipment. A driver preferably an engine 12 coupled to a transmission 14. The engine 12 may be a 5.7 L (350 cid) V-8 spark ignition engine. The transmission 14 may be a four speed automatic GM 4L60E. The pinion torque meter 16 may be a 0-2035 Nm (0-18,000 lb-in) range, temperature measurement sensor 19 may be a J-type thermocouple, test control and data acquisition may be preferably software oriented with a data acquisition rate such as 1 data sample every 20 seconds. Of course, these components and/or frequencies can vary depending on the particular test embodiment. Other drivers other than engines coupled to transmission may be utilized in other embodiments.

The test axles are preferably built up with standard gears using accepted industry procedures. The bearings are specified as to brand and part number for consistent test conditions in evaluating lubricants and may be made of 52100 steel. The following procedure may be used to ensure that the test housing is clean and everything is properly assembled and adjusted to minimize lubricant performance scatter from undesired influences:

1. Obtain test axle from inventory. Axles are ordered in batch quantities from a manufacturer's dealership

2. Remove axle cover for inspection.

3. Remove differential bearing caps, differential, and ring gear.

4. Mark and layout bearing caps, shims, and bearings for re-assembly.

5. Clean axle housing, pinion, all bearings, ring gear and differential with Stoddard solvent and heptane.

6. Re-assemble differential assembly into axle housing with corresponding shims and bearings. Torque differential bearing caps.

7. Brush gear contact pattern grease onto ring gear, rotated pinion several times while loading ring gear with wedge.

8. Take digital picture of ring gear contact pattern. Verify that contact pattern is OK to run.

9. Clean off contact pattern grease by using heptane.

10. Install test axle cover with thermocouple using manufacturer-approved factory RTV sealant.

11. Let RTV sealant cure for a minimum of 4 hours prior to filling axle with test fluid.

12. Charge axle with 2200 grams of test oil.

13. Install axle into test stand.

Since this test uses an actual automotive sub-assembly, a number of additional variables may be introduced that may affect the test results such as gear and housing manufacture; however the number of steps used in inspecting the test differential before tests greatly reduces the possibility of test variability due to extraneous factors. In the actual automotive R-392 test there are even more additional uncontrolled variables.

The current test run is preferably stopped by a mechanical vibration detector 19, which is attached to the axle beam near the box of the differential 18. When the amplitude of the vibration is greater than a certain level 60 as seen in FIG. 2 and/or if the slope of vibration 62 exceeds or reaches a certain valve, the test may be stopped. To have an idea of the level of vibration, an accelerometer vibration detector is preferably mounted onto the housing of the differential. An example of the vibration trace measured by the accelerometer vibration detector 19 monitoring the test is shown in FIG. 2. After the test run, the differential is preferably at least partially disassembled and the bearings and gears are inspected for bearing fatigue damage, fatigue damage mode, bearing load zone and gear wear. Lubricant metal content is also preferably analyzed. Any anomalies are noted. A predetermined slope of iron count versus cycles may be utilized as at least one pass fail criteria as shown in FIG. 5. A slope of ppm iron over cycles of less than six as shown by slope 64 has been found to be a presently preferred passing criteria.

Three gear oils were used in this bear durability rig test development. They are shown in Table III. Gear Oil A is a reference oil while Gear Oils B and C are the experimental test oils. Table III shows their SAE viscosity grades and kinematic viscosity at 100° C.

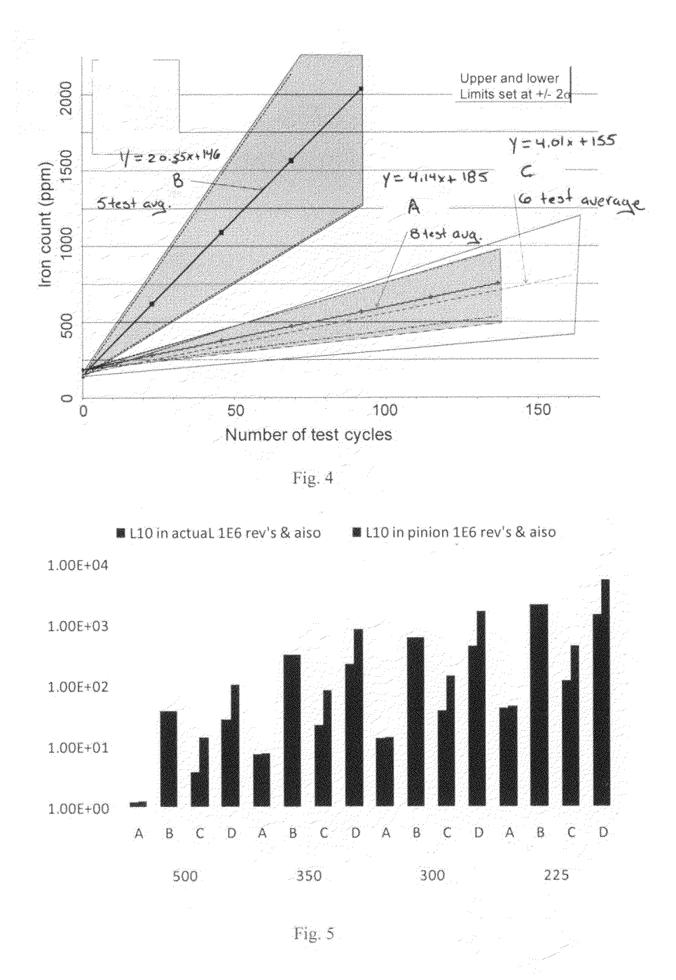

Fatigue damage on the pinion head bearing is shown in FIG. 3. This damage illustrated is similar to that obtained from an R-392 vehicle test has gone through the entire 14-day or over 10,000-mile test process. While the fatigue damage on the bearing has grown large, the initiating mechanism was most likely inclusion or PSO initiated by denting. The spalled surface appears rough.

Fatigue damage on a bearing from the bench run test is similar to that shown in FIG. 3 in actual test results. The initiating mechanism was most likely again of surface origin from dents or perhaps some inclusions, as in the R392 tests. The roughness or texture of the spalled surface 66 can be easily observed as compared to smooth surface 68 as is initially provided about the bearing surface. The fatigue damage conditions look the same as in the R-392 tests.

Life data from the test method is given in Table IV. Results from three different formulations are shown on a relative basis. All bearing failures were at the pinion head bearing location. FIG. 4 shows the used oil iron analysis results. Gear oil B has the highest slope of used oil iron. Gear oils A and C have lower slope values and are nearly equal in slope. FIG. 5 also shows that the wear rates of the same three gear oils. Wear, ridging, and rippling ratings on the gears shown in Table IV appear to correlate with the wear rate. However, under this testing condition, pitting on gears hardly occurs. The trend of the slope of the used oil iron does not agree with the bearing durability life suggesting that the great majority of the wear comes from pinion and ring gear.

TABLE IV
Life test data and gear damages evaluation for
three lubricant chemistries

| | Median^{a} | | | | | |
|---|---|---|---|---|---|---|
| Gear | cycles | Test oil | Pinion & | Pinion & | Pinion & | Pinion & |
| oils | to | iron | ring gear | ring gear | ring gear | ring gear |
| tested | failure | slope | wear | ridging | rippling | pitting |
| A | 132 | 4.58 | 8, 8 | 9.1, 9.8 | 9.8, 9.9 | 10, 10 |
| B | 97 | 21.74 | 6.8, 7 | 6.6, 7.4 | 6.2, 8.8 | 10, 10 |
| C | 162 | 2.57 | 7.7, 8 | 8.8, 9.7 | 9.5, 10 | 10, 10 |

^{a}This is a L50 life

The bearing cone contact stress and EHL fim thickness for the four bearings calculated from the loads and speeds carried out under city driving and union pass driving conditions are shown in Table V below. In turn, the life adjustment factors, a_{ISO}, calculated from these cone loads, lubricant viscosities and assuming a constant debris factor of 0.2 for all bearings are also shown in Table V. We illustrate these two driving conditions for the calculation here is because they have the two larger pinion torques applied. For the city driving load segments, the maximum inner race-roller line contact stresses are calculated. Bearing loads can be rating of the bearing is based on a 4 GPa line contact determined by using a bearing manufacturer catalogue approach. Bearing maximum roller loads can then be determined with Sjoval's integrals. Since the static stress on the inner race roller contact for a 180 degree load zone, the maximum inner race-roller contact stresses for the applied roller load can then be determined without determining precise bearing component diameters and contact lengths although approximate diameters and angles are provided on bearing manufacturer's web sites that can be used in determining raceway contact load per unit length and entrainment velocities for EHL film thicknesses calculations.

TABLE V
Cone contact stress, EHL film thickness, and a_{ISO}

| | | Contact | | |
|---|---|---|---|---|
| Pinion | | stress, | hc, micro- | |
| torque | Bearing | GPa | meters | a_{ISO} |
| 500 | A | 2.38 | 0.048 | 0.164 |
| | B | 1.6 | 0.045 | 0.205 |
| | C | 2.16 | 0.019 | 0.104 |
| | D | 1.47 | 0.021 | 0.105 |
| 350 | A | 1.98 | 0.138 | 0.308 |
| | B | 1.37 | 0.126 | 0.521 |
| | C | 1.8 | 0.067 | 0.207 |
| | D | 1.22 | 0.074 | 0.105 |

From this information, the maximum inner race contact stresses can be calculated; the results are shown in Table V. Under the highest pinion torque of 500 ft-lb, the maximum inner race contact stress at the pinion head bearing position (A) is found to be 2.38 GPa. Likewise, the values for the pinion tail bearing position (B), the first carrier bearing position (C), and the second carrier bearing position (D) are found to be 1.60 GPa, 2.16 GPa, and 1.47 GPa, respectively. Thus, the pinion head bearing position (A) is the most severely stressed position among the four bearings. The pinion tail bearing position (B) and the second carrier bearing position (D) are essentially in the extended life region because of the relatively low contact stresses.

The EHL film thickness was calculated by assuming the lubricant was a SAE 90 grade (ISO 220) oil and all bearings were operated under the same temperature of 120° C. (250° F.). The results are shown in Table IV. At the highest pinion torque of 500 ft-1b, EHL film thicknesses were found to be about 0.042 micro-meters for the pinion head bearing position (A), 0.038 micro-meters for the pinion tail bearing position (B), 0.016 micro meters for the first carrier bearing position (C) and 0.018 micro-meters for the second carrier bearing position (D). The pinion positions are reasonably well lubricated, but the two carrier bearings are probably in the mixed lubrication regime. This correlates well with surface distress seen in post test examinations. Table III also shows that a_{ISO} has an inverse relationship with the load and a positive proportional relationship with EHL film thickness. These types of relationships are expected.

To obtain a more quantitative assessment of which bearing should be expected to fail first, the applicant did a L10 calculation to assess the situation. The calculation was carried out under two conditions: one was in terms of the actual revolution and the other was based on the pinion shaft revolution. The results are shown in FIG. 5. Clearly the pinion head bearing at Position A operating under any of the four load cycle segments has the shortest L10 life. This is followed by the carrier bearing at Position C. These results are not a surprise since fatigue life in principle is predominantly influenced by the load factor.

To gain better confidence that the preferred test conditions will produce results are produced in the right range of the bearing life as it is designed for these bearings, the applicants carried out the percent probability of failure calculation for each of the four bearings. The results are shown in Table IV where the probability of failure for each bearing is shown for different lives in terms of the calculated combined bearing system L50 life. The bearing system life results from the combined probability for any of the four bearings failing at a given point in time. Since the lives of the other bearings are much greater than the pinion head bearing, there is a very low probability of the other bearings failing earlier when the Pinion head bearing is most likely to fail. The ring gear support bearing C is the only other bearing with any possibility of failing early and it's failure is relatively very low. Again these results clearly indicate the vulnerability of the pinion head bearing for fatigue failure.

In order for a bearing durability rig test to be useful, it must first reproduce the fatigue failure mode as seen in the vehicle field test. The bearing fatigue damage shown in FIG. 3 can be obtained from a R-392 field test with vehicles as well as from taken from an end-of-test test run of the applicants' method on text rig 10. In both cases, the pinion head bearing 32 fatigue damage occurs before the pinion tail bearing 46 and the two carrier bearings 40,42. The results of calculation on contact stress, L10 life, and bearing percent probability of failure based on the bearing supplier catalog information clearly predict that this is supposed to happen. In fact, the bearing percent probability of failure for the pinion head bearing 32 of 49% at the bearing system L50 life is much larger than the next largest percent probability of 2% for the first carrier bearing 40. On the other hand, if occasionally the fatigue damage occurs at bearings other than the pinion head bearing, then we can surely conclude that the damage is abnormal.

At the present, the preferred test is stopped by the mechanical vibration detector instead of an accelerometer vibration detector. Software may enable the use of accelerometer vibration detector as the switch to stop the test. So far a total of test runs have been carried but and consistently demonstrated successful reduction to practice. The experience shows that 95% of the runs indicate when the vibration reaches to a level sufficient to trigger switching off the test, only the bearing inner race shows fatigue damage. Pinion pitting rarely occurs. In fact, there was one run that shows a pinion pitted badly while the bearing suffered no damage, but the damage seen on the pinion did not create sufficient vibration to stop the test.

A new bearing durability rig test has been successfully developed. The rig test may simulate closely the load cycles of the R-392 field vehicle test which was developed specifically to evaluate the differential gear box bearing performance while preferably eliminating non-impact portions of the R-392 field test. Axle bearing performance for different gear oil formulations can now be successfully evaluated and compared in this newly developed test protocol. Test time and lubricant development time can be reduced with increased convenience and better controls on the test environment for improving test consistency and reproducibility.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A bearing durability test method comprising the steps of:
providing a test rig having a driver coupled to a transmission and to a differential supporting opposing axle portions, said opposing axle portions connected to at least one dynamometer and a controller in communication with at least the driver and the at least one dynamometer;
performing a test by operating the driver and the at least one dynamometer with predetermined segment cycles of applied pinion torque on the differential and axle speeds on the axle portions with the controller controlling at least one of axle speed and a torque related to an applied pinion torque during the test;
wherein a first segment provides for a low pinion torque and a low axle speed, and a second segment provides for a low pinion torque and a high axle speed; and the segments are a portion of the segment cycles whereby a first time period of operation occurs for the first segment followed by a second time period of operation for the second segment, and segment cycles are repeated as repeating cycles for at least one of forty eight hours and a failure event at which the test is terminated.

2. The method of claim 1 wherein the failure event is determined at least in part by an output from a vibration sensor in communication with the differential.

3. The method of claim 2 wherein the failure event corresponds to a predetermined increase in vibration of the differential during the test.

4. The method of claim 1 wherein the repeating cycles have similar first and second segments.

5. The method of claim 4 wherein the repeating cycles repeat the first and second segments in each of the repeating cycles.

6. The method of claim 1 further comprising a third segment characterized by a low pinion torque and a low axle speed and the third segment follows the second segment in the cycle.

7. The method of claim 6 further comprising a fourth segment characterized by a low pinion torque and a high axle speed and the fourth segment follows the third segment in the cycle.

8. The method of claim 7 further comprising a fifth segment characterized by a low pinion torque and a high axle speed and the fifth segment precedes the first segment in the cycle.

9. The method of claim 1 wherein the low pinion torque is further characterized as being less than about 750 lb-ft.

10. The method of claim 1 wherein the low pinion torque is less than about 500 lb-ft.

11. The method of claim 1 wherein the high axle speed is further characterized as being above about 500 rpm.

12. The method of claim 1 wherein the low axle speed is defined as being less than about 200 rpm.

13. The method of claim 1 further comprising the step of at least partially disassembling differential prior to connecting to engine and the at least one dynamometer prior to performing the test, and further comprising the step of at least partially disassembling the differential after terminating the test and inspecting at least one of the pinion head bearing raceway for fatigue spalling failures and the pinion head bearing inner race rib roller for end scuffing.

14. The method of claim 1 further comprising the step of analyzing used oil in the differential for iron following termination of the test.

15. The method of claim 14 whereby the test is passed if the iron count in parts per million per number of test cycles is less than about six.

16. A bearing durability test method comprising the steps of:
providing a test rig having a driver coupled to a differential supporting opposing axle portions, said opposing axle portions connected to at least one dynamometer, a controller in communication with at least the driver and the at least one dynamometer, and a vibration sensor in communication with the differential; and
operating the driver and the at least one dynamometer with predetermined segment cycles of applied pinion torque on the differential and axle speeds on the axle portions with the controller controlling at least one of axle speed and a torque related to an applied pinion torque during a test;
wherein a first segment provides for a low pinion torque and a low axle speed, and a second segment provides for a low pinion torque and a high axle speed; and the segments are a portion of the segment cycles whereby a first time period of operation occurs for the first segment and a second time period of operation for the second segment, and the test continues until the vibration sensor provides an output to the controller whereby the controller distinguishes the output as a failure event, and the controller stops the test.

17. The test method of claim 16 wherein after stopping the test, the differential is disassembled and at least the pinion head bearing is inspected for fatigue spalling failure.

18. The test method of claim 16 wherein when the pinion head bearing is also inspected for rib-roller end scuffing following the test.

19. A bearing durability test method comprising the steps of providing a test rig having a driver coupled to a differential supporting opposing axle portions, said opposing axle portions connected to dynamometers and a controller in communication with at least the driver and dynamometers;
operating the driver and dynamometers with predetermined segment cycles of applied pinion torque on the differential and axle speeds on the axle portions with the controller controlling at least one of axle speed and a torque correlating to an applied pinion torque;
wherein a first segment provides for a low pinion torque and a low axle speed, and a second segment provides for a low pinion torque and a high axle speed; and the segments are a portion of the segment cycles whereby a first time period of operation occurs for the first segment followed by a second time period of operation for the second segment, followed by another first time period of the first segment and then followed by another second time period of the second segment, and segment cycles are repeated as repeating cycles for at least one of forty eight hours and a failure event at which the test is terminated.

20. The method of claim 19 wherein the failure event is determined at least in part by an output from a vibration sensor in communication with the differential.
